(19) United States
(12) Patent Application Publication
(10) Pub. No.: US 2007/0001326 A1
(43) Pub. Date: Jan. 4, 2007

(54) Vaporizer

(76) Inventors: Masayuki Toda, Yamagata (JP); Masaki Kusuhara, Tokyo (JP)

Correspondence Address: YOUNG & THOMPSON, 745 SOUTH 23RD STREET, 2ND FLOOR, ARLINGTON, VA, 22202, US

(21) Appl. No.: 10/573,258

(22) PCT Filed: Sep. 27, 2004
(86) PCT No.: PCT/JP04/14103

§ 371 Date: Jul. 24, 2006

(30) Foreign Application Priority Data
Sep. 26, 2003 (JP) 3003-335605

(51) Int. Cl. B01F 3/04

(52) U.S. Cl. 261/155; 261/116; 261/DIG. 65

(57) ABSTRACT

There is provided a vaporizer in which the path of a reaction tube can be kept long, and vaporization can be promoted evenly by radiation heat from a heater by agitating a carrier gas into which a source solution is dispersed in the direction crossing the passing direction of the gas, the agitation being made by a centrifugal force produced when the gas passes through the reaction tube. A carrier gas into which a source solution consisting of a liquid or powder is dispersed is supplied from the upstream side to a spiral reaction tube 103, and the carrier gas into which the source solution is dispersed and which passes through the reaction tube 103 is vaporized by radiation heat from a heater 104.

### TECHNICAL FIELD

The present invention relates to a vaporizer for vaporizing, by radiation heat from a heater, a carrier gas into which a source solution is dispersed and which passes through a reaction tube.

### BACKGROUND ART

Patent Document: Unexamined Japanese Patent Publication No. 2000-216150

In recent years, in the field of electronic device, as the circuit density increases, smaller size and higher performance of electronic device have further been demanded. For example, like SRAM (Static Random Access read write Memory) in which storage operation of information is performed by a combination of transistors, EEPROM (Electrically Erasable and Programmable Read Only Memory), or DRAM (Dynamic Random Access Memory) in which storage operation of information is performed by a combination of transistors and capacitors, not only the fulfillment of function of electronic device achieved simply by a circuit configuration only but also the fulfillment of function of device achieved by utilizing the characteristics of the material itself such as a functional thin film has become advantageous.

Therefore, a dielectric material used for an electronic part is desired to be made a thin film. One method for making such a material a thin film is the CVD process.

This CVD process has features of a film forming rate higher than that of the PVD process, sol-gel process, and other film forming methods, easy manufacture of multilayer thin film, and the like. Also, the MOCVD process is a CVD process in which a compound containing an organic substance is used as a raw material for forming a thin film, and has advantages of high safety, no mixture of halide in a film, and the like.

The material used for the MOCVD process is generally solid powder or liquid. In this process, the material is put in a vessel, and is generally heated at a reduced pressure and vaporized in a vaporizer, and thereafter is sent into a thin-film forming apparatus by a carrier gas.

FIG. 4 is a system block diagram of a vaporization system for the MOCVD process (refer to Patent Document 1).

In FIG. 4, reference numeral 10 denotes a supply section for supplying a plurality of source solutions etc. to a vaporizer 1.

The supply section 10 includes a gas cylinder 11 filled with a carrier gas (for example, N₂ or Ar), an oxygen cylinder 12 filled with oxygen, a water storage tank 13 in which cooling water is stored, a plurality of reservoirs 14 to 17 in which raw materials for ferroelectric thin film (for example, Sr(DPM)₂, Bi(C₆H₅)₃, Ta(OC₂H₅)₅ as three kinds of organometallic complexes) and THF (tetrahydrofuran) as a solvent are stored, a gas feed pipe 18 connected to the gas cylinder 11 and the vaporizer 1, an oxygen feed pipe 19 connected to the oxygen cylinder 12 and the vaporizer 1, a water feed pipe 20 and a water distribution pipe 21, which are connected to the water storage tank 13 and the vaporizer 1, liquid feed pipes 22 to 25 which are connected to the reservoirs 14 to 17 and the vaporizer 1, and a manifold 26 connected to the reservoirs 14 to 17 and the gas cylinder 11.

In the path of the gas feed pipe 18 are provided a valve 18a and a mass flow controller 18b, in the path of the oxygen feed pipe 19 are provided a valve 19a, a mass flow controller 19b, and a valve 19c, in the path of the water feed pipe 20 is provided a valve 20a, in the path of the liquid feed pipe 22 for solvent are provided a valve 22a and a mass flow controller 22b, in the paths of the liquid feed pipes 23 to 25 for complex are provided valves 23a to 25a and mass flow controllers 23a to 25b, respectively, and in the path of the manifold 26 are provided valves 26a to 26d, an air purge 26e, and a valve 26f. The liquid feed pipes 23 to 25 are branched so as to be connected to the liquid feed pipe 22, and are provided with valves 23c to 25c, respectively.

The carrier gas filled in the gas cylinder 11 is supplied to the vaporizer 1 while the flow rate thereof is controlled by the mass flow controller 18b by opening the valve 18a of the gas feed pipe 18. Also, the carrier gas filled in the gas cylinder 11 is set into the reservoirs 14 to 17 by opening the valve 26f and the valves 26a to 26d of the manifold 26 and by closing the release state of the air purge valve 26e. Thereby, the interiors of the reservoirs 14 to 17 are pressurized by the carrier gas, and the stored source solutions are pushed up in the liquid feed pipes 22 to 25 the tip end of which are put in the solutions, and are transported into connection pipes 2 to 5 of the vaporizer 1 after the flow rates thereof have been controlled by the mass flow controllers 22b to 25b.

Also, at the same time, the oxygen (oxidizing agent), the flow rate of which is controlled to a fixed value by the mass flow controller 19b, is transported from the oxygen cylinder 12 to the vaporizer 1.

Further, by opening the valve 20a of the water feed pipe 20, the cooling water in the water storage tank 13 circulates in the vaporizer 1 to cool the vaporizer 1.

In the illustrated example, connection pipes 27 to 30 are provided side by side along the axis line direction of the vaporizer 1. Actually, however, the connection pipes 27 to 30 are provided radially and alternately by connection pipes 31 and 32 connected to the water feed pipe 20 or the water distribution pipe 21 leading to the water storage tank 13.

The source solution stored in the reservoirs 14 to 16 is a solution in which a liquid or solid organometallic complex (Sr(DPM)₂, Bi(C₆H₅)₃, Ta(OC₂H₅)₅) is dissolved in THF, which is a solvent, at ordinary temperature. Therefore, if the source solution is allowed to stand as it is, the organometallic complex is deposited by the evaporation of THF solvent, and finally becomes in a solid state. For this reason, in order to prevent the interiors of the liquid feed pipes 23 to 25 that come into contact with the source solution from being clogged by the solid-state organometallic complex, the interiors of the liquid feed pipes 23 to 25 and the interior of the vaporizer 1 should be cleaned by THF in the reservoir 17 after the film forming work has been finished. At this time, the cleaning operation is performed in a section from the outlet side of the mass flow controller 23b to 25b to the vaporizer 1, and the THF stored in the reservoir 17 is washed away after the work has been finished.

FIG. 3 is a sectional view showing a construction of an essential portion of the vaporizer 1. In FIG. 3, the vaporizer 1 includes a disperser 2 to which the gas feed pipe 18 is connected, a reaction tube 3 connected continuously to the downstream side of the disperser 2, and a heater 4 covering the periphery of the reaction tube 3.

The disperser 2 has a gas passage 5 located coaxially with the gas feed pipe 18. Between a start end upstream port 5a and a terminus end injection port 5b of the gas passage 5, the tip ends of the connection pipes 27 to 30 are located (in FIG. 3, only the opposedly arranged connection pipes 28 and 29 are shown). Thereby, the source solutions stored in the reservoirs 14 to 16 can be supplied into the gas passage 5. Also, the disperser 2 is formed with a cooling path 6 which communicates with the connection pipes 31 and 32 and in which the cooling water in the water storage tank 13 circulates. Further, the disperser 2 includes a rod 7 one end of which is located on the upstream side of the start end upstream port 5a of the gas feed pipe 18 and the other end of which is located at the position of the terminus end injection port 5b, and pins 8 for supporting the other end of the rod 7. One end of the rod 7 is held by pins 9 provided near the end portion of the gas feed pipe 18.

As the heater 4, a cylindrical ceramic heater that surrounds the reactor tube 3 substantially over the total length thereof or a spiral heater is used.

In the above-described configuration, a hole is penetratingly provided in the disperser 2, and the rod 7 having an outside diameter (4.48 mm) smaller than the inside diameter (4.50 mm) of the hole is embedded so as to be located coaxially with the axis line of the hole. The gas passage 5 is formed in a space formed between the disperser 2 and the rod 7. The rod 7 is held in a positioned state by the machine screws 9.

The cross section width of the gas passage 5 is 0.02 mm. At this time, the cross section width of the gas passage 5 is preferably 0.005 to 0.10 mm. If the cross section width is narrower than 0.005 mm, fabrication is difficult to do, and if it exceeds 0.10 mm, a high-pressure carrier gas must be used to increase the velocity of carrier gas.

From the upstream side of the gas passage 5, the carrier gas is introduced through the gas feed pipe 18. Since the source solution is dripped in this carrier gas from the tip ends of the connection pipes 27 to 30 located in midway portions of the gas passage 5, the source solution is dispersed into the carrier gas passing through the gas passage 5.

Thereby, the carrier gas into which the source solutions are dispersed is injected from the terminus end injection port 5b on the downstream side of the gas passage 5 into the reaction tube 3. The carrier gas, into which the source solutions are dispersed and which flows in the reaction tube 3, is heated and vaporized by the heater 4, and thereafter is sent to a thin-film forming apparatus, not shown.

### DISCLOSURE OF THE INVENTION

### Problems to be Solved by the Invention

In the vaporizer 1 configured as described above, the periphery of the reaction tube 3 is covered with the heater 4. Therefore, there arise problems in that it is difficult to keep a vaporization path length (reaction time) of carrier gas into which the source solutions are dispersed, which corresponds to the length of the reaction tube 3, long, there is produced a difference in heating temperature due to radiation heat of the heater 4 between a portion near the outer periphery of the reaction tube 3 and a portion near the center thereof, and sufficient vaporization cannot be accomplished without a change in size of the vaporizer 1 depending on the kind, dispersion quantity, etc. of the source solution.

The present invention has been made to solve the above problems, and accordingly an object thereof is to provide a vaporizer capable of keeping the reaction time of carrier gas long.

### Means for Solving the Problems

To achieve the above object, a vaporizer described in claim 1 is characterized by including a spiral reaction tube to which a carrier gas into which a source solution consisting of a liquid or powder is dispersed is supplied from the upstream side, and a heater for heating and vaporizing the carrier gas into which the source solution is dispersed and which passes through the reaction tube by means of radiation heat.

A vaporizer described in claim 2 is characterized in that the heater is arranged on the inside of the reaction tube.

### Advantages of the Invention

According to the vaporizer in accordance with the present invention, a carrier gas into which a source solution consisting of a liquid or powder is dispersed is supplied from the upstream side to the spiral reaction tube, and the carrier gas into which the source solution is dispersed and which passes through the reaction tube is vaporized by radiation heat from the heater. Thereby, the path of the reaction tube can be kept long, and the vaporization of carrier gas is promoted evenly by radiation heat from the heater because the carrier gas into which the source solution is dispersed is agitated in the direction crossing the passing direction by a centrifugal force produced when the carrier gas passes through the reaction tube.

According to the vaporizer described in claim 2, the arrangement of the heater on the inside of the reaction tube contributes to making the vaporizer small in size.

### BEST MODE FOR CARRYING OUT THE INVENTION

A vaporizer in accordance with the present invention, which is used as a vaporizer for MOCVD, will now be described with reference to the accompanying drawings.

FIG. 2 is a system block diagram of a vaporization system for MOCVD having the vaporizer in accordance with the present invention, and FIG. 1 shows an essential portion of the vaporizer in accordance with the present invention, FIG. 1(A) being a front view of the essential portion, and FIG. 1(B) being a sectional view of a reaction tube.

In FIG. 2, reference numeral 10 denotes a supply section for supplying a plurality of source solutions etc. to a vaporizer 101. The configurations of the supply section 10 and a disperser 2 are the same as those of the conventional art shown in FIG. 4, so that the detailed explanation thereof is omitted.

The vaporizer 101 includes a disperser 2 to which a gas feed pipe 18 is connected, a reaction tube 103 connected continuously to the downstream side of the disperser 2, and a heater 104 covering the periphery of the reaction tube 103.

The reaction tube 103 has a midway portion formed into a spiral shape. For example, a mechanical separation distance from the disperser 2 to a thin-film forming apparatus, not shown, is the same as explained in the conventional art, and therefore the size of equipment of the whole of vaporization system can be made almost the same. Also, since the reaction tube 103 is formed into a spiral shape, the distance of a substantial reaction portion of the distance from the disperser 2 to the thin-film forming apparatus, not shown, is kept long.

As the heater 104, a rod-shaped heater such as a ceramic heater is arranged in the center of the spiral portion of the reaction tube 103 substantially over the total length of the reaction tube 103. The heater 104 may be formed by a spiral tube body located on the inside or on the outside of the reaction tube 103, or may be formed by the spiral tube bodies located on the inside and outside of the reaction tube 103.

In the above-described configuration, the source solution is dripped from the tip ends of the connection pipes 27 to 30 connected to the dispersion section 2, and is dispersed into the carrier gas introduced from the gas feed pipe 18.

Thereby, the carrier gas into which the source solutions are dispersed is injected from the downstream side of the dispersion section 2 to the reaction tube 103. The carrier gas into which the source solutions are dispersed and which flows in the reaction tube 103 is heated and vaporized by the heater 104, and thereafter is sent into the thin-film forming apparatus, not shown.

At this time, since the reaction tube 103 is formed into a spiral shape, as shown in FIG. 1(B), a turbulent flow due to centrifugal force occurs in the reaction tube 103 in the direction crossing the conveyance direction of carrier gas, and therefore a state in which the carrier gas is agitated on the inside and outside of the reaction tube is formed, so that the carrier gas can be vaporized evenly by radiation heat from the heater 104.

### BRIEF DESCRIPTION OF THE DRAWINGS

FIG. 1 is views showing an essential portion of a vaporizer in accordance with the present invention, FIG. 1(A) being a front view of the essential portion, and FIG. 1(B) being a sectional view of a reaction tube;

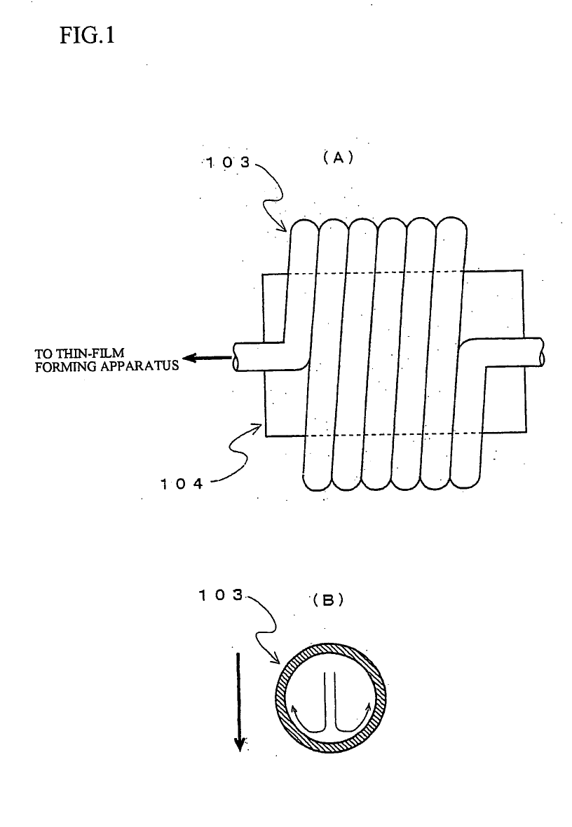

FIG. 2 is a system block diagram of a vaporization system for MOCVD having a vaporizer in accordance with the present invention;

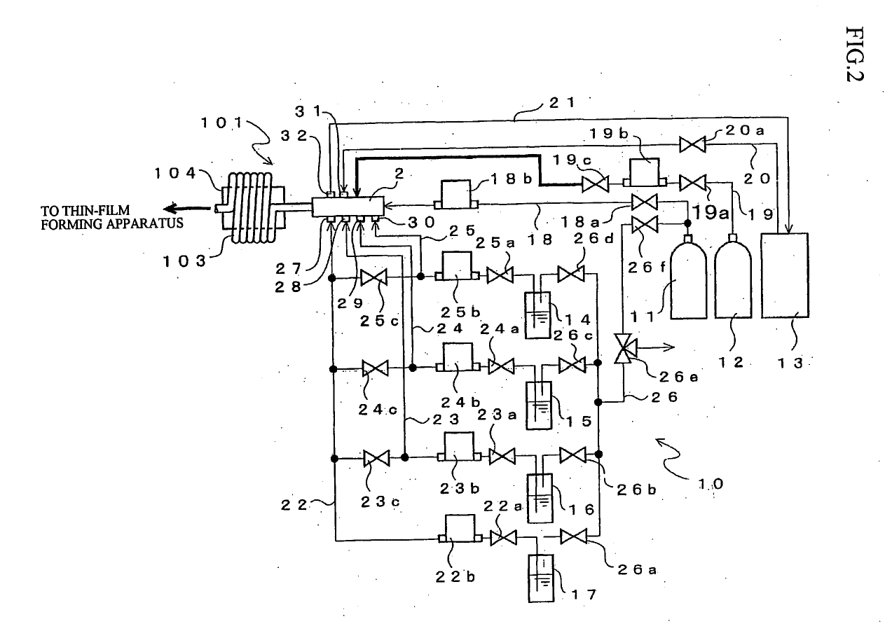

FIG. 3 is a longitudinal sectional view of a dispersion section of a vaporizer; and

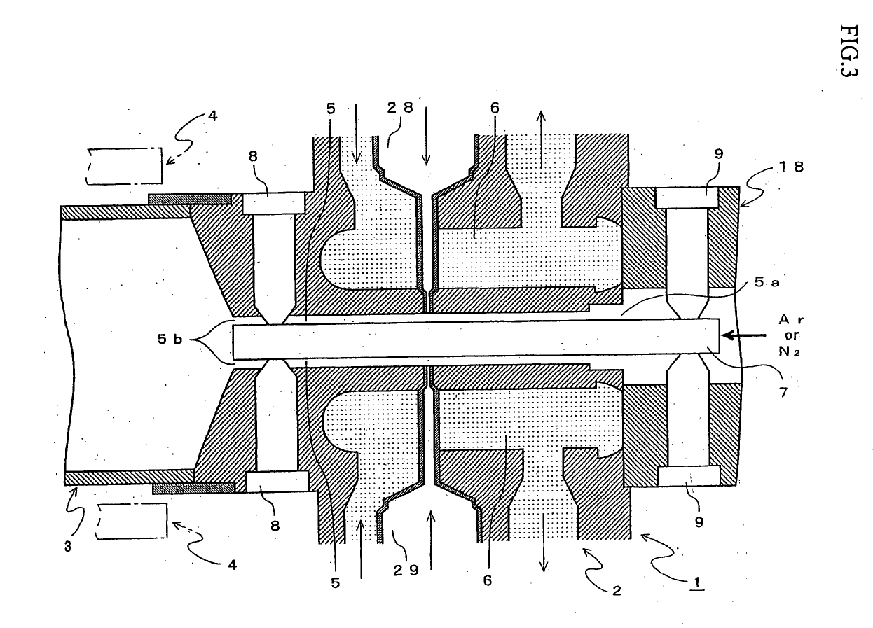

FIG. 4 is a system block diagram of a vaporization system for MOCVD having a conventional vaporizer.

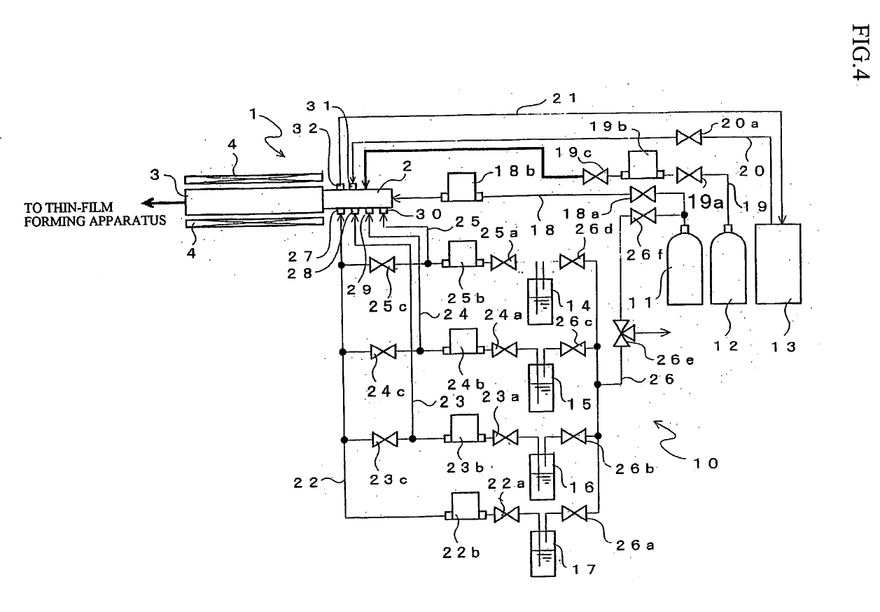

### EXPLANATION OF SYMBOLS

101 . . . vaporizer
103 . . . reaction tube
104 . . . heater

### INDUSTRIAL APPLICABILITY

According to the vaporizer in accordance with the present invention, a carrier gas into which a source solution consisting of a liquid or powder is dispersed is supplied from the upstream side to the spiral reaction tube, and the carrier gas into which the source solution is dispersed and which passes through the reaction tube is vaporized by radiation heat from the heater. Thereby, the path of the reaction tube can be kept long, and the vaporization of carrier gas is promoted evenly by radiation heat from the heater because the carrier gas into which the source solution is dispersed is agitated in the direction crossing the passing direction by a centrifugal force produced when the carrier gas passes through the reaction tube.

According to the vaporizer described in claim 2, the arrangement of the heater on the inside of the reaction tube contributes to making the vaporizer small in size.

1. A vaporizer characterized by comprising a spiral reaction tube to which a carrier gas into which a source solution consisting of a liquid or powder is dispersed is supplied from the upstream side, and a heater for heating and vaporizing the carrier gas into which the source solution is dispersed and which passes through the reaction tube by means of radiation heat.

2. The vaporizer according to claim 1, characterized in that the heater is arranged on the inside of the reaction tube.
